(19) United States
(12) Patent Application Publication
(10) Pub. No.: US 2009/0316405 A1
(43) Pub. Date: Dec. 24, 2009

(54) Configurable LED lighting device

(76) Inventor: Chen-Hui Lai, Taipei City (TW)

Correspondence Address: Chen-Hui, Lai, 11F, No.156, Sec 1, Jianguo N. Rd., Taipei City, 104, TW

(21) Appl. No.: 12/214,610

(22) Filed: Jun. 23, 2008

(51) Int. Cl. F21V 21/00; F21V 29/00

(52) U.S. Cl. 362/249.01; 362/373

(57) ABSTRACT

A configurable LED lighting device, comprises: a plurality of seat units, each provided with at least one connecting member at a side thereof; a plurality of combining plates, for connecting the connecting members of the seat units, respectively, and at least one fixing member, for fixing the combining plates to the seat units so as to construct the seat units into the lighting device with a desired size. Thereby, the seat units can be such constructed that the lighting device has a desired size and provides a desired diffusion angle of light.

### BACKGROUND OF THE INVENTION

1. Technical Field

The present invention relates to a configurable LED (Light Emitting Diode) lighting device, and more particularly, to a configurable lighting device capable of providing different light diffusion angles and sizes for meeting spatial needs in the environment where the configurable lighting device is to be installed.

2. Description of Related Art

Though LED (Light Emitting Diode) has the advantages of low power-consuming and high brightness, it tends to give out high heat while emitting light. Thus, an LED lighting device is typically equipped with a heat-diffusion device so as to properly discharge the heat generated by the LED, thereby achieving the maximum efficiency of the LED.

Please refer to FIGS. 1 and 2 for a conventional LED lighting device. Such LED lighting device 10 primarily comprises a fin-shaped light housing 11, a driving circuit 12 and a plurality of LEDs 13. A heat-conductive aluminum board 111 is settled in the housing 11 and the LEDs 13 arranged on the heat-conductive aluminum board 111 are designed to be lighted by the driving circuit 12 so that the heat generated by the lighted LEDs 13 can be directly transferred to the light housing 11 through the heat-conductive aluminum board 111 and then diffuse from each fin formed outside the light housing 11.

While the fin-shaped light housing effectively discharges the heat brought by the LEDs 13, it has some particular shortcomings in its installation and manufacture.
1. Though the light housing 11 performs a competent heat-diffusion effect when being used in a lighting device with a relatively small size, it fails to give out the same effect in a lighting device with a relatively large size. That is, when the light housing 11 is made relatively large to match the lighting device with the relatively large size, the heat tens to accumulate at a center of the light housing but not goes to a periphery of the light housing where the heat could easily diffuse. Consequently, the inferior heat-diffusion effect can significantly reduce the efficiency and life of the LEDs.
2. The preformed integrated fin-shaped light housing is not configurable to provide a variable size fitting the environment where it is to be installed and to provide the needed brightness. Therefore, the related manufacturers have to design numerous molds for making various light housings that have different dimensions and present different diffusion angles of LED light so as to satisfy as many needs as possible. Since in the conventional approach, there is no single aspect of a light device that meets all environments, the various light housings require raised manufacturing costs and represents increased material stocks. In view of the modern trend of low costs and stocks, the conventional light housing needs to be improved.

Hence, the present invention is aimed at the issue how to effectively improve an LED lighting device so as to make the same configurable to provide different diffusion angles and sizes for meeting the spatial needs while a heat-diffusion effect it performs is not subject to its reduced size.

### SUMMARY OF THE INVENTION

The primary objective of the present invention is to provide a configurable LED lighting device, which comprises a plurality of seat units, each provided with at least one connecting member at a side thereof. The connecting members, in cooperation with a plurality of combining plates, combine the seat units into an integral.

Thereby, the seat units can be constructed into a desired size and the constructed seat units can provide different light diffusion angle by configuring the combining plates.

To achieve the aforementioned objective, the present invention provides a configurable LED lighting device, which comprises:

a plurality of seat units, each provided with at least one connecting member at a side thereof;

a plurality of combining plates, for connecting the connecting members of the seat units, respectively, and

at least one fixing member, for fixing the combining plates to the seat units so as to construct the seat units into the lighting device with a desired size.

In the configurable LED lighting device as describe above, each of the combining plates is formed as a shape of “I”, wherein two ends thereof are provided with a plurality of combining holes so that some combining holes may be used to make the seat units such combine with each other that a particular diffusion angle is formed by the seat units, thereby accomplishing the lighting device providing the desired light diffusion angle.

In the configurable LED lighting device as describe above, each of the seat units comprises:

at least one bearing member that serves for a heat-diffusion function and has at least one assembling side;

a plurality of light emitting diodes, arrayed at each of the assembling side of the bearing member and separated by an equidistant or a non-equidistant interval; and

at least one driving circuit, for lighting up the light emitting diodes.

In the configurable lighting device as describe above, one side of the bearing member is composed of a plurality of fins to form a fin-shaped appearance.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 illustrates a conventional LED lighting device;

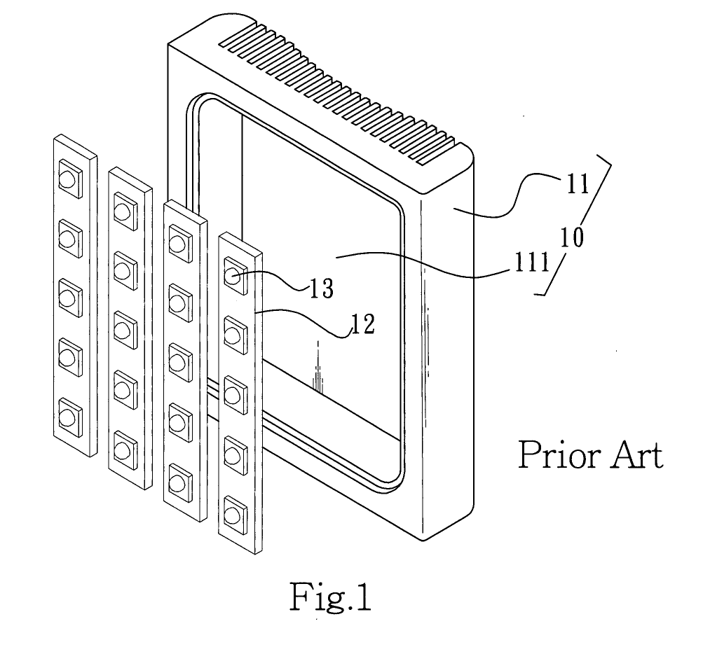

FIG. 2 further provides a structure of the conventional LED lighting device;

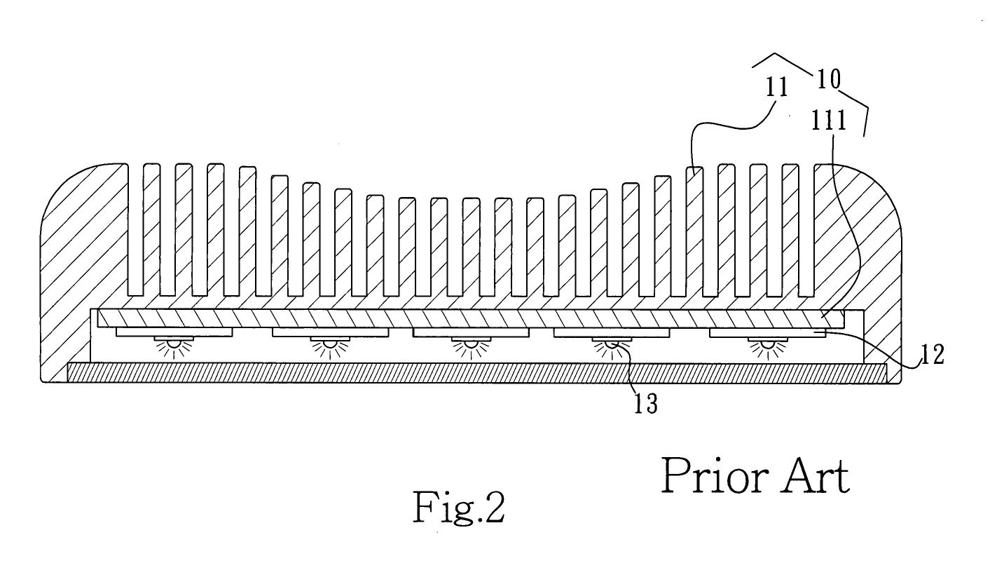

FIG. 3 is an exploded view of a configurable LED lighting device according to the present invention;

FIG. 4 is a sectional view of the configurable LED lighting device according to the present invention, wherein seat units thereof are such configured to provide a diffusion angle of 180 degrees;

FIG. 5 is another sectional view of the configurable LED lighting device according to the present invention, wherein the seat units are such configured to provide a diffusion angle greater than 180 degrees; and

FIG. 6 is another sectional view of the configurable LED lighting device according to the present invention, wherein the seat units are such configured to provide a diffusion angle smaller than 180 degrees.

### DETAILED DESCRIPTION OF THE PREFERRED EMBODIMENT

For the purpose of explaining the technical means and effects of the present invention, the following description is made with reference to a preferred embodiment to be read in conjunction with the accompanying drawings.

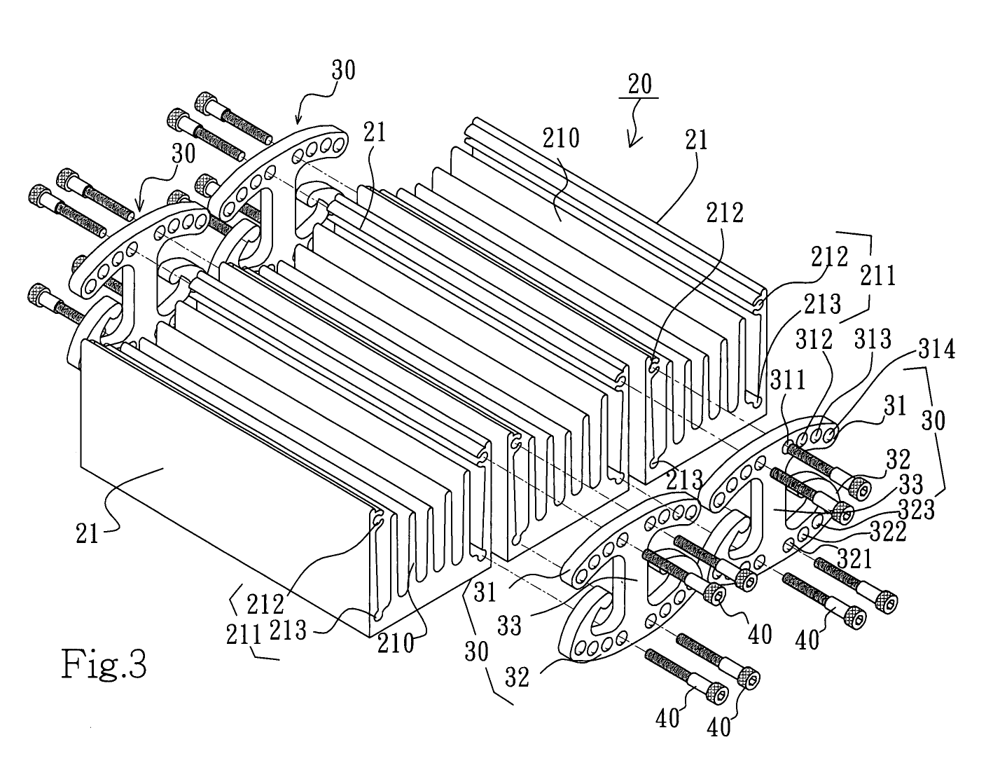

Please refer to FIG. 3 for an exploded view of a configurable LED lighting device according to the present invention.

As can be seen in the drawings, the configurable LED lighting device of present invention comprises a plurality of seat units 20 and a plurality of combining plates 30. The combining plates 30 are provided between the seat units 20 so as to combine the seat units 20 into an integral lighting device with a desired size.

Each of the seat unit 20 comprises at least one bearing member 21, a plurality of light-emitting diodes arrayed on the bearing member 21 and a driving circuit (not shown) for lighting up the light-emitting diodes. The bearing member 21 has one side thereof provided with a plurality of heat-diffusion fins 210 for presenting an increased area of heat-diffusion while having an opposite side thereof serving as an assembling side for receiving the light emitting diodes and the driving circuit (not shown) to be assembled thereon by any means without limitation. The bearing member 21 has two ends thereof provided with a plurality of connecting members 211, each containing a first positioning portion 212 and a second positioning portion 213 for connecting and positioning a corresponding said combining plates 30 so that the seat units 20 can be constructed into the lighting device with a desired size.

According to the present preferred embodiment, the combining plate 30 is consist of at least two horizontal parts 31, 32 and at least one vertical part 33. The vertical part 33 is located between the horizontal parts 31, 32 for connecting the horizontal parts 31, 32, thereby giving the combining plate 30 a shape of “I”. Moreover, the vertical part 33 defines the horizontal part 31 into a left side and a right side, each being formed with a plurality of combining holes that are designed to couple with the first positioning portion 212 of the bearing member 21. In the present embodiment, the combining holes are defined as a first combining hole 311, a second combining hole 312, a third combining hole 313 and a fourth combining hole 314. The horizontal part 32 below the vertical part 33 is also defined into a left side and a right side, each being formed with a plurality of combining holes that are designed to couple with the second positioning portion 213 of the bearing member 21. In the present embodiment, the combining holes are defined as a first combining hole 321, a second combining hole 322, a third combining hole 323 and a fourth combining hole 324. Thus, by combining the combining holes at the upper and lower ends of the combining plates 30 with the first positioning portions 212 and the second positioning portions 213, the seat units 20 can be constructed into the lighting device having a desired size and an adjustable diffusion angle as needed.

Referring to FIG. 3 again, the first positioning portions 212 and the second positioning portions 213 may be made to have any structure without limitation as long as the same can be combined with the combining holes 311, 312, 313,314 and the combining holes 321, 322, 323, 324 of the combining plate 30. The first positioning portions 212 and the second positioning portions 213 may be respectively formed as a threaded hole while the positioning portions and the combining holes may be combined with a fixing member 40, wherein the fixing member 40 may be a screw (as shown in FIG. 3). The threaded hole is intrgrally formed on the fin 210 of the bearing member 21 of the lighting device so that the fixing member 40 can pass the combining holes of the combining plates 30 to couple with the threaded hole and get fixed.

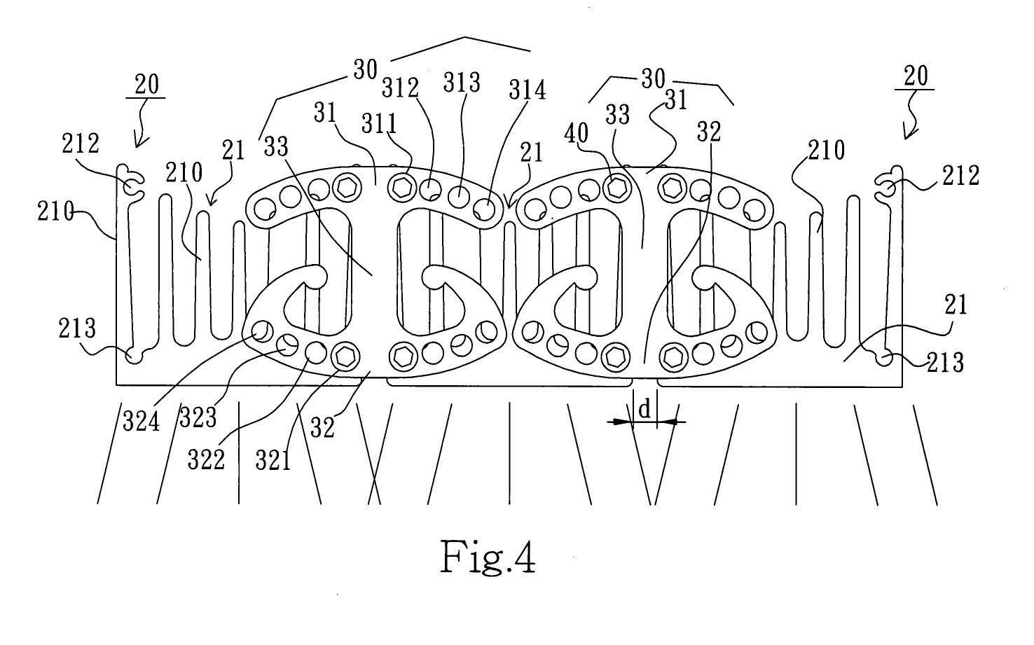

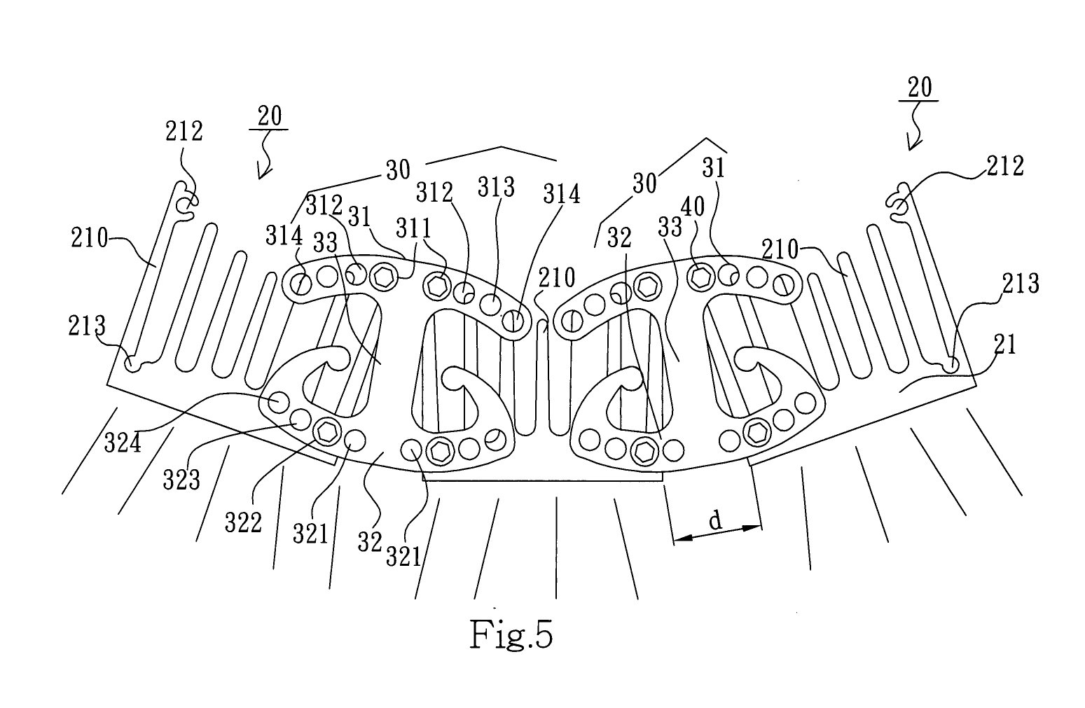

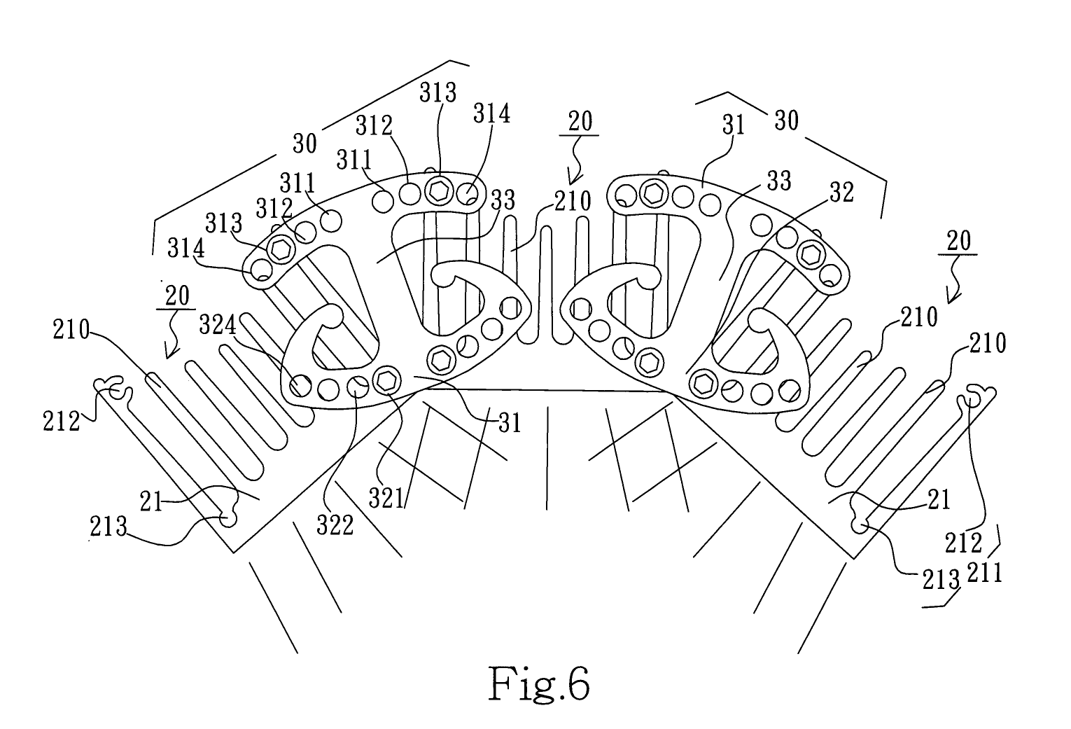

Now referring to FIGS. 4 to 6, FIG. 4 is a sectional view of the configurable LED lighting device according to the present invention, wherein seat units thereof are such configured to provide a diffusion angle of 180 degrees, while FIG. 5 is another sectional view of the configurable LED lighting device according to the present invention, wherein the seat units are such configured to provide a diffusion angle greater than 180 degrees, and FIG. 6 is another sectional view of the configurable LED lighting device according to the present invention, wherein the seat units are such configured to provide a diffusion angle smaller than 180 degrees.

On practical assembling the seat units 20, it is only needed to combine the first positioning portions 212 at the sides of the seat units 20 and the second positioning portions 213 at the same sides of the seat units 20 with the combining holes of the combining plates 30 by the fixing members 40, respectively, the resultant lighting device is configured to provide a light diffusion angle of 180 degrees (as shown in FIG. 4). Numbers of the seat units 20 and the combining plates 30 to be used may be determined by the desired size of the lighting device. When an environment where the disclosed lighting device is to be installed requires a relatively large lighting area, the first positioning portion 212 of each said seat unit 20 can be combined with the first combining hole 311 of a corresponding said combining plate 30, and the second positioning portion 213 can be adjusted according to a desired diffusion angle, and then the second positioning portion 213 can be combined with one of the second combining hole 322 of the horizontal part 32, the third combining hole 323 and the fourth combining hole 324 by the fixing member 40 so as to provide the resultant lighting device having a light diffusion angle greater than 180 degrees (as shown in FIG. 5). Alternatively, when an environment where the disclosed lighting device is to be installed requires a concentrated and highly bright light, the first positioning portion 212 of each said seat unit 20 can be combined with the third combining hole 313 (or the second combining hole 312) of a corresponding said combining plate 30, and the second positioning portion 213 is configured according to a desired diffusion angle, and then combined with the second combining hole 322 (or the first combining hole 321) so as to provide the resultant lighting device performing the concentrated and highly bright illumination (as shown in FIG. 6).

Again, seeing FIGS. 4 and 5, in addition to the advantage of present invention that the lighting device can be configured to a shape meeting the spatial needs so as to efficiently reduce the manufacturing costs and the weight of the lighting device, while the seat units 20 are combined by the combining plate 30, a heat-diffusion space d is formed between each two adjacent seat units 20, wherein the further the seat units 20 are separated, the larger the heat-diffusion space d is so that the problem of the prior art that a light housing made relatively large to tens to accumulate the heat at a center thereof but not goes to a periphery thereof where the heat could easily diffuse.

What is claimed is:

1. A configurable LED lighting device, comprising:
a plurality of seat units, each provided with at least one connecting member at a side thereof;
a plurality of combining plates, for connecting the connecting members of the seat units, respectively, and
at least one fixing member, for fixing the combining plates to the seat units so as to construct the seat units;
wherein the combining plates has at least two horizontal parts and at least one vertical part that connects between the two horizontal parts.

2. The configurable LED lighting device of claim 1, wherein each of the seat units comprises:
at least one bearing member that serves for a heat-diffusion function and has at least one assembling side;
a plurality of light emitting diodes, arrayed at each of the assembling side of the bearing member and separated by an equidistant or a non-equidistant interval; and
at least one driving circuit, for lighting up the light emitting diodes.

3. The configurable LED lighting device of claim 1, wherein each of the horizontal parts comprises a plurality of combining holes.

4. The configurable LED lighting device of claim 2, wherein one side of the bearing member is composed of a plurality of heat-diffusion fins to form a fin-shaped appearance.

5. The configurable LED lighting device of claim 1, wherein the fixing member is a screw.
